(19) United States
(12) Patent Application Publication
(10) Pub. No.: US 2007/0018451 A1
(43) Pub. Date: Jan. 25, 2007

(54) Safety device for threadedly engaged portions of a quick-coupling

(76) Inventor: Massimo Arosio, Treviglio (Bergamo) (IT)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/480,177

(22) Filed: Jun. 30, 2006

(30) Foreign Application Priority Data
Jul. 20, 2005 (IT) MI2005A-001383

(51) Int. Cl. F16L 35/00

(52) U.S. Cl. 285/81; 285/82; 285/305

(57) ABSTRACT

A safety device for threadedly engaged portions of a quick-coupling comprises a first quick-coupling portion, including a thread, and a circumferential slot, and a second quick-coupling portion, having a respective thread and assembled with the thread of the first portion, said second quick-coupling portion having a circumferential region which, at a free end thereof and at said circumferential slot, comprises a hammer enlarged portion which can be coupled with the circumferential slot after having fully assembled the quick-coupling portions.

### BACKGROUND OF THE INVENTION

The present invention relates to a safety device for threadedly engaged portions of a quick-coupling or connecting device.

As is known, quick-couplings including a male part and a female part, comprising a plurality of elements which are mostly made by turning processes.

The quick-coupling forming portions either comprise ring recesses for engaging therein resilient gaskets, or have assembling threads to be mutually coupled to one another.

In such an application, is very important to prevent the threaded connection from loosening in the time, in particular as the quick-coupling is used in hydraulic systems, for example for connecting demolition hammers or the like implements. In fact, in such a hydraulic system, the operating pressures and hydraulic fluid pulsating frequencies cause the threaded connection to be progressively released.

To overcome the above drawback, it has been already attempted to connect by a glue the threaded parts, but the achieved results have not been found as fully satisfactory; moreover, the glueing operations require a comparatively long time.

### SUMMARY OF THE INVENTION

Accordingly, the main object of the present invention is to overcome the above mentioned drawbacks of the prior art and provide a threaded connection between the parts or portions constituting a quick-coupling, while assuring that, even in a case of a high pressure hydraulic fluid, and large system pulsating frequencies, the threaded connection is not loosened, to prevent the threaded portions from being disengaged from one another in extreme cases.

According to one aspect of the present invention, the above mentioned object is achieved in that a first portion of the quick-coupling, having a first portion thread, comprises a circumferential slot, whereas a second portion of the quick-coupling, having a second portion thread engaged with the first portion thread, comprises a circumferential wall which, at a free end thereof and at said circumferential slot, comprises a hammer-like circumferential enlarged portion to be coupled with said circumferential slot after having fully assembled the quick-coupling portions.

Further advantages of the invention will become more apparent from the following disclosure and the dependent claims.

### BRIEF DESCRIPTION OF THE DRAWINGS

The subject matter according to the present invention will be disclosed in a more detailed manner hereinafter with reference to an embodiment thereof, given only by way of an example, and shown in the accompanying drawings, where:

FIG. 1 is a schematic view, as partially cross-sectioned, of a male portion of a prior quick-coupling;

FIG. 2 is a schematic view, as partially cross-sectioned, showing two tubular elements of a quick-coupling, threadedly assembled with one another and made according to the present inventions;

FIG. 3 shows, on an enlarged scale, that portion of the quick-coupling including a circumferential slot and a circumferential enlarged portion before the connection operation thereof; and

FIG. 4 shows that portion of the quick-coupling including the circumferential slot, upon assembling to the hammer-like enlarged portion.

### DESCRIPTION OF THE PREFERRED EMBODIMENT

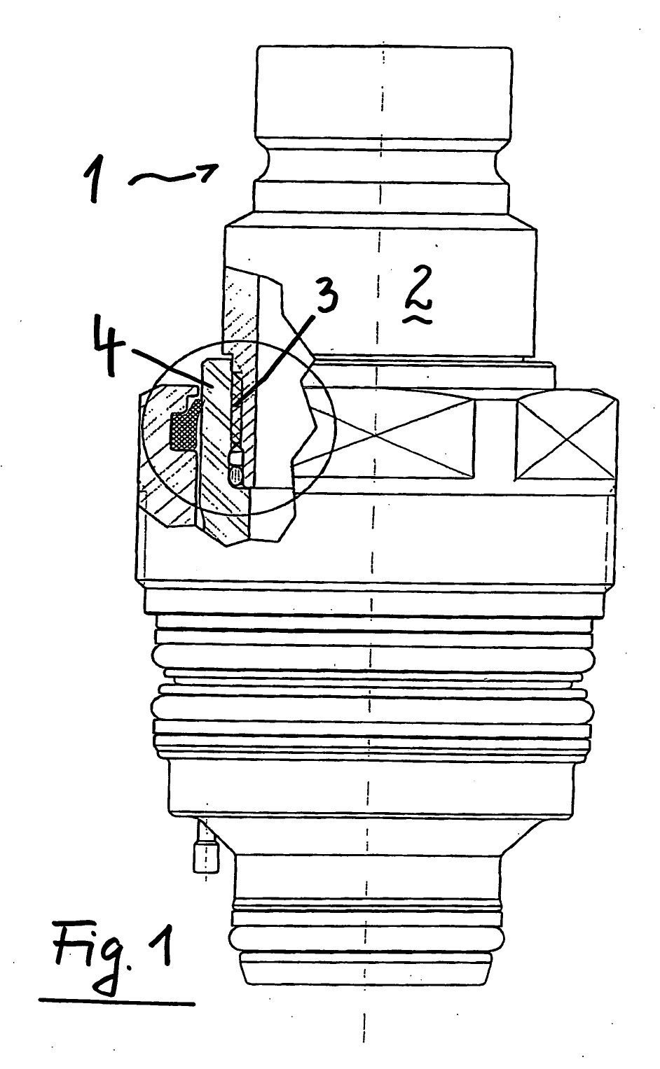

As shown in FIG. 1, the male part or portion 1 of a quick-coupling or connection comprises a projecting element 2 engaged, by a threaded type of engagement 3, with a tubular element 4 of the quick-coupling 1.

More specifically, the projecting element 2 is coupled to said tubular element 4 by an outer thread and an inner thread, said threads being generally indicated by the reference number 3.

Between the body 2 and body 4 a resilient gasket, indicated by the reference number 5, is advantageously provided.

As stated, in a prior embodiment, shown in FIG. 1, the thread 3 is not locked and, accordingly, the portions 2 and 4 can detach from one another.

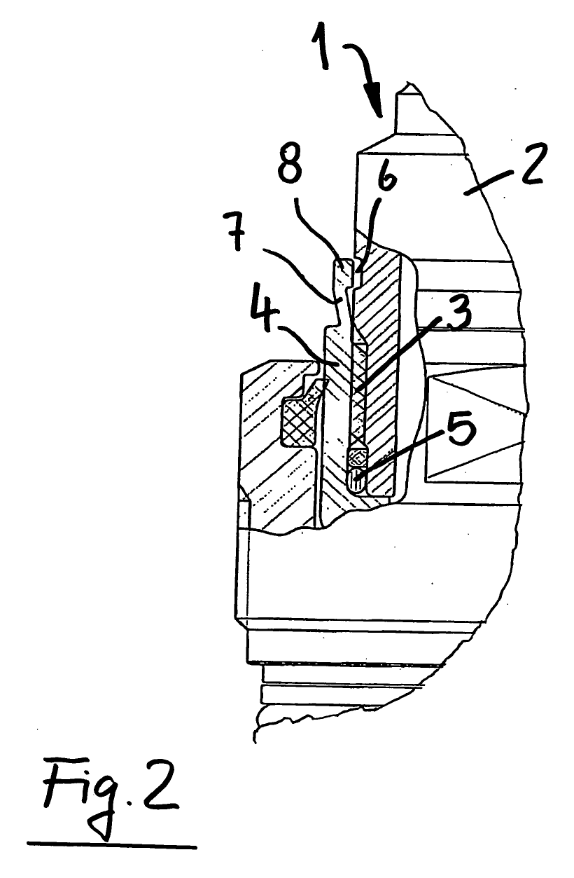

According to the invention (FIGS. 2, 3, 4), the portion 2 is herein provided with an outer circumferential slot 6 and, from the tubular portion 4 a circumferentially extending land or rib portion 7 projects.

The rib 7, which is of a comparatively thin construction, ends with a hammer-like enlarged portion 8. Said hammer-like enlarged portion 8, with the coupling in an assembled condition, being oriented toward the circumferential slot 6.

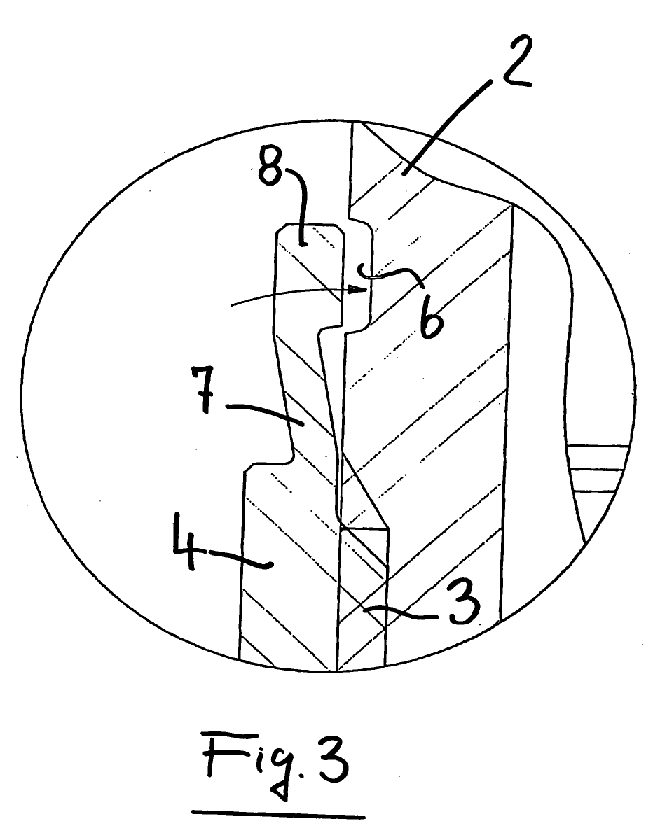

To allow the portion 2 of the quick-coupling 1 to be easily thread engaged in the tubular body 4, the circumferential wall 7 is slightly outward radially inclined, thereby as the threads 3 are mutually engaged, no objectable contact of the body of the portion 2 and the hammer-like enlarged portion 8 will occur. As is clearly shown in FIG. 3, up to a full thread engagement 3 of the portion 2 in the tubular element 4, owing to the provision of outward radially slanted wall 7, the hammer-like enlarged portion 8 will not contact the outer wall of the portion 2.

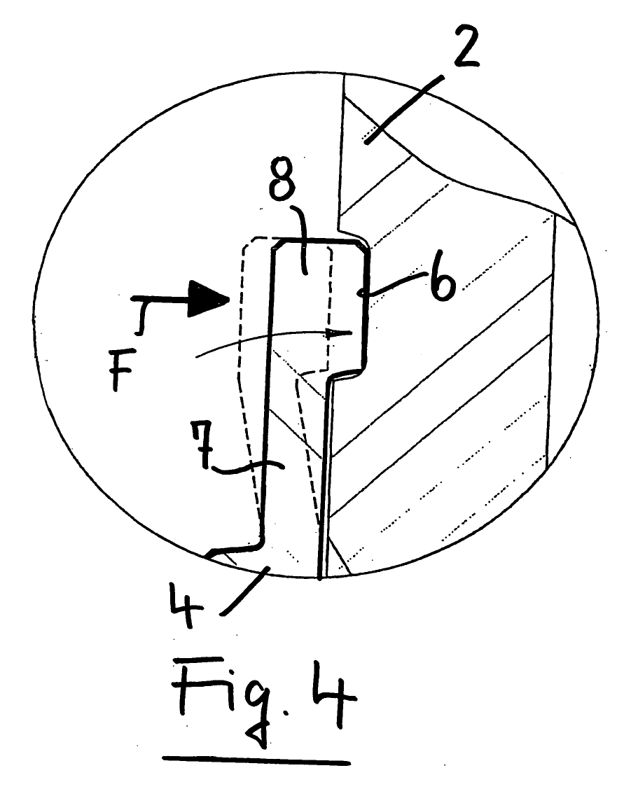

Upon fully assembling said portions 2 and 4, and with the circumferential enlarged portion 8 precisely coinciding with the circumferential slot 6, as shown in FIG. 3, by a force F transmitted by a press, as shown in FIG. 4 by the arrow (f), the enlarged portion 8, by a plastic deformation of the wall 7, will brought to a permanent type of contact with the slot 6, thereby locking the portion 2 with respect to the tubular element 4, and safely preventing any mutual movements of said two constructional elements as well as any movements inside the thread.

1. A safety device for threadedly engaged portions of a quick-coupling (1), characterized in that said quick-coupling comprises a first quick-coupling portion (2), having a first quick-coupling portion thread (3), and a circumferential slot (6), and a second quick-coupling (1) portion (4), having a second quick-coupling portion thread (3) and threadedly engaged with said first quick-coupling portion (2) thread (3), said second quick-coupling portion having a circumferential wall (7) which, at a free end thereof and at said circumferential slot (6), comprises a hammer-like circumferential enlarged portion (8) adapted to be coupled with said circumferential slot (6) after having fully assembled said portions (2, 4).

2. A safety device, according to claim 1, characterized in that said hammer-like enlarged portion (8) is supported by a comparatively thin wall (7).

3. A safety device, according to claim 1
characterized in that said hammer-like enlarged portion (8) supporting wall (7), before assembling said portions, is slightly outward radially inclined.

4. A safety device, according to claim 1, characterized in that with said device in a fully assembled condition, as said hammer-like enlarged portion (8) is arranged at said circumferential slot (6), said hammer-like enlarged portion (8) is subjected to a circumferential force (F) thereby causing said hammer-like enlarged portion (8) to permanently contact said circumferential slot (6).
